(19) United States
(12) Patent Application Publication
(10) Pub. No.: US 2026/0108808 A1
(43) Pub. Date: Apr. 23, 2026

(54) FLEXIBLE NETCODE ARCHITECTURE

(71) Applicant: Roblox Corporation, San Mateo, CA (US)

(72) Inventors: João Tiago Alves Gonçalves, San Mateo, CA (US); Andreas Haeberlen, Philadelphia, PA (US); Kayvon Fatahalian, Redwood City, CA (US)

(73) Assignee: Roblox Corporation, San Mateo, CA (US)

(21) Appl. No.: 19/365,700

(22) Filed: Oct. 22, 2025

Related U.S. Application Data
(60) Provisional application No. 63/710,965, filed on Oct. 23, 2024.

(51) Int. Cl. A63F 13/358

(52) U.S. Cl. CPC A63F 13/358

(57) ABSTRACT

Some implementations relate to methods, systems, and computer readable media to manage object states in a distributed multiuser environment, such as a multiplayer game environment. A client device receives an authoritative update from a designated authority node specifying a state of at least one object for a given frame. The client performs a rollback check to determine whether the locally predicted state differs from the authoritative update. If a discrepancy exists, the client rolls back the local state to a time corresponding to the authoritative update and applies the update to obtain an updated object state. A subsequent object state is predicted based on the updated object state and used to update a game state maintained at the client. Visual discrepancies between a last shown position and the updated game state are reconciled before rendering the object for the next frame.

### CROSS-REFERENCE TO RELATED APPLICATIONS

This application claims priority under 35 U.S.C. § 119(e) to U.S. Provisional Patent Application No. 63/710,965 , filed Oct. 23, 2024, and titled “FLEXIBLE NETCODE ARCHITECTURE,” the entire contents of which are incorporated by reference herein.

### TECHNICAL FIELD

This application relates generally to distributed multiuser virtual experiences, and more particularly but not exclusively, relates to methods, systems, and computer-readable media to manage object states using a netcode architecture that enables speculative state predictions, authoritative rollbacks, and reconciliation of discrepancies within virtual experiences hosted on a virtual experience platform.

### BACKGROUND

Current approaches to managing object states in distributed multiuser virtual experience environments face significant challenges due to network latency and synchronization issues. In a multiplayer gaming environment as an example, clients located in different regions may experience varying degrees of delay when communicating with a server. The latency results in inconsistent object states across clients, where players may see objects in different positions or states from their true position, as determined by an authoritative server. Solutions rely on a range of strategies to mitigate the effects of latency. The strategies apply in a one-size-fits-all manner and fail to accommodate the diverse nature of virtual experience environments and object behaviors, as well as having other shortcomings.

### SUMMARY

Various implementations described herein relate to methods, systems, and computer-readable media to manage object states using a netcode architecture.

According to one aspect, an authoritative update is received, at a client device, from a designated authority node, the authoritative update specifying a state of at least one object in a game for a specific frame. A rollback check is performed to determine if the state specified in the authoritative update differs from a locally predicted state of the at least one object at the client device. If the locally predicted state differs from the state specified in the authoritative update, the locally predicted state is rolled back to a time corresponding to the authoritative update. The authoritative update is applied to the rolled-back state to obtain an updated object state, and a subsequent object state is predicted based on the updated object state. A game state of the game is updated based on the predicted object state. One or more discrepancies are reconciled between a last shown position of the at least one object in the game and a position of the object in the updated game state. After reconciling, the at least one object in the game is rendered for the subsequent frame.

In some implementations, performing the rollback check includes determining if the difference between the authoritative update and the locally predicted state meets a threshold.

In some implementations, an application programming interface (API) is provided that is usable by a developer of the game to define a policy that specifies a criterion that indicates when to perform reconciling the one or more discrepancies and that specifies techniques to perform reconciling the one or more discrepancies, where the reconciling is based on the updated object state obtained after applying the authoritative update.

In some implementations, the policy specifies compensation techniques selected from a group including interpolation, extrapolation, incoming delay, latency concealment, attribute scaling, time warp, or combinations thereof.

In some implementations, the API enables selection between using a predicted object state and an interpolated visual estimate when reconciling the one or more discrepancies.

In some implementations, an API is provided that enables a developer of the game to specify custom logic to perform the rollback check, where the custom logic includes rules to determine whether to roll back the locally predicted state based on custom criteria.

In some implementations, the custom criteria includes an object type of the at least one object.

In some implementations, the custom criteria includes a magnitude of difference between the locally predicted state and the authoritative update.

In some implementations, predicting the object state for the subsequent frame includes simulating object behavior based on the updated object state after applying the authoritative update and one or more prior predicted or authoritative states.

In some implementations, reconciling the one or more discrepancies is performed by accessing a history of last shown positions of the object across multiple frames and smoothing the updated game state accordingly, where the smoothing is performed by a callback function.

In some implementations, rendering the at least one object in the game is based on a visual presentation state that incorporates corrections from reconciling the one or more discrepancies.

According to another aspect, a computing device includes one or more processors, and memory coupled to the one or more processors with instructions stored thereon that, when executed by the one or more processors, cause the one or more processors to perform or control performance of operations including receiving, at a client device, an authoritative update from a designated authority node, the authoritative update specifying a state of at least one object in a game for a specific frame. The operations further include performing a rollback check to determine if the state specified in the authoritative update differs from a locally predicted state of the at least one object at the client device. If the locally predicted state differs from the state specified in the authoritative update, the operations further include rolling back the locally predicted state to a time corresponding to the authoritative update. The operations further include applying the authoritative update to the rolled-back state to obtain an updated object state, and predicting a subsequent object state based on the updated object state. The operations further include updating a game state of the game based on the predicted object state. The operations further include reconciling one or more discrepancies between a last shown position of the at least one object in the game and a position of the object in the updated game state. After reconciling, the operations further include rendering the at least one object in the game for the subsequent frame.

In some implementations, performing the rollback check includes determining if the difference between the authoritative update and the locally predicted state meets a threshold.

In some implementations, the operations further include providing an API that is usable by a developer of the game to define a policy that specifies a criterion that indicates when to perform reconciling the one or more discrepancies and that specifies techniques to perform reconciling the one or more discrepancies.

In some implementations, the policy specifies compensation techniques selected from a group including interpolation, extrapolation, incoming delay, latency concealment, attribute scaling, time warp, or combinations thereof.

According to another aspect, a non-transitory computer-readable medium is provided with instructions stored thereon that, when executed by a processor, cause the processor to perform or control performance of operations. The operations include receiving, at a client device, an authoritative update from a designated authority node, the authoritative update specifying a state of at least one object in a game for a specific frame. The operations further include performing a rollback check to determine if the state specified in the authoritative update differs from a locally predicted state of the at least one object at the client device. If the locally predicted state differs from the state specified in the authoritative update, the operations further include rolling back the locally predicted state to a time corresponding to the authoritative update. The operations further include applying the authoritative update to the rolled-back state to obtain an updated object state, and predicting a subsequent object state based on the updated object state. The operations further include updating a game state of the game based on the predicted object state. The operations further include reconciling one or more discrepancies between a last shown position of the at least one object in the game and a position of the object in the updated game state. After reconciling, the operations further include rendering the at least one object in the game for the subsequent frame.

In some implementations, performing the rollback check includes determining if the difference between the authoritative update and the locally predicted state meets a threshold.

In some implementations, the operations further include providing an API that is usable by a developer of the game to define a policy that specifies a criterion that indicates when to perform reconciling the one or more discrepancies and that specifies techniques to perform reconciling the one or more discrepancies.

In some implementations, the policy specifies compensation techniques selected from a group including interpolation, extrapolation, incoming delay, latency concealment, attribute scaling, time warp, or combinations thereof.

In some implementations, the API enables selection between using a predicted object state and an interpolated visual estimate when reconciling the one or more discrepancies.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to manage object states using a netcode architecture, in accordance with some implementations.

FIG. 2 is a flow diagram illustrating an example method to manage object states using a netcode architecture, in accordance with some implementations.

FIG. 3 is a flow diagram illustrating another example method to manage object states in a virtual experience, in accordance with some implementations.

FIG. 4 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Some solutions assign authority over object states to a central server, which sends periodic updates to clients. Clients rely on the updates to correct discrepancies in locally predicted states. While the server-authority model enables consistency, it introduces delays that degrade player experience, particularly when real-time or near-real-time responsiveness is important. Techniques such as client-side prediction are used to address the issue by enabling clients to speculate on the state of objects until the next authoritative update is received. Incorrect predictions can lead to visual discrepancies, such as objects jumping between positions or being in places where they are no longer relevant, causing player frustration.

Extrapolation and interpolation are two prediction techniques used to fill the gap between server updates. Extrapolation predicts future object positions based on the last known velocity and direction of the object, while interpolation estimates positions based on previous and current states. The extrapolation and interpolation techniques, while effective for some scenarios, struggle when object movements are non-linear or subject to complex interactions, such as in virtual experiences with rapidly changing environments or unpredictable player behavior. Misaligned predictions lead to inconsistencies in the virtual experience, with objects appearing to stutter or behave unnaturally, further impacting the player experience.

Another solution is rollback, where the system rewinds the game state to a prior point when a discrepancy between the predicted and authoritative states is detected. While rollback can correct errors in object placement, the rollback is limited by predefined thresholds and does not adapt well to varying contexts. Rollback mechanisms that are too rigid may overcorrect, leading to unnecessary state rewinds that disrupt the flow of the virtual experience. Rollback mechanisms that are too lenient may leave significant discrepancies unresolved, resulting in objects that seem out of place or inconsistent with the actions of other players.

One or more implementations described herein address the above and other shortcomings of the foregoing techniques, by managing object states using a netcode architecture. As an example, the techniques (described in further detail below) address the challenge of maintaining consistency between authoritative and predicted object states across distributed nodes in a multiuser virtual experience environment, such as a multiplayer game environment or other type of virtual environment. Techniques are described in which a client device receives authoritative updates from a designated authority node for specified frames, compares those updates to locally predicted states, and performs rollbacks when discrepancies are detected. The techniques include generating predictions for subsequent frames, updating game state based on those predictions, reconciling discrepancies for visual consistency, and rendering objects based on the reconciled view.

Various examples of the techniques will at times be described herein in the context of a multiplayer gaming environment, such as an online electronic game. It is understood that such references to a game, gaming environment, game functionality, game players, etc. are for illustrative purposes. The features of the techniques described herein may be applied to other types of multiuser virtualized experience environments that may not necessarily involve games, such as training environments, educational environments, other collaborative environment, etc.

An example of a netcode architecture of various implementations is a configuration that coordinates the management of object states between client devices and a virtual experience server. The architecture supports maintaining responsiveness for player input on client devices while synchronizing object state consistency across a shared virtual environment. In some configurations, the server provides authoritative updates of object states, while each client predicts object behavior locally to render interactive frames. The architecture includes mechanisms for identifying and reconciling differences between predicted and authoritative object states, including rollback evaluation, reconciliation logic, and visual smoothing. Developer-accessible APIs can be used to define custom policies for prediction, rollback thresholds, and reconciliation strategies, allowing the architecture to be tuned for performance and visual consistency in latency-sensitive multiplayer experiences.

In some implementations, an API is provided that enables developers to define custom rollback policies and reconciliation techniques. This includes the ability to specify conditions under which rollbacks are to be performed, such as based on object types or the magnitude of difference between predicted and authoritative states. The reconciliation logic may incorporate compensation strategies such as, for example, interpolation, extrapolation, latency concealment, time warping, or others. The strategies are selectable by the developer through the API to enable fine-grained control over how inconsistencies in object positions or states are resolved for display to the user.

In some implementations, a visual state is introduced, which is distinct from the authoritative or predicted game states. The visual state stores corrections computed during reconciliation and may be used for rendering purposes. By maintaining a dedicated visual view, the system enables discrepancies to be corrected over time without disrupting the underlying game logic. The rendering engine uses the reconciled visual state to produce consistent, smooth output even when mispredictions and rollbacks have occurred, improving the player experience without adversely affecting gameplay accuracy or other aspects of an experience.

In some implementations, the disclosed techniques enable prediction logic to be driven by either prior authoritative or prior predicted states, depending on availability. In some cases, client devices simulate object behavior locally until authoritative information is received. The rollback and reconciliation logic can access historical state information and apply smoothing functions across multiple frames.

Some technical advantages of various features include the ability to perform rollback operations selectively based on developer-defined criteria, rather than relying on hardcoded thresholds or generalized heuristics. By exposing rollback logic through an API, the disclosed netcode architecture enables customization according to game-specific object types, player roles, or gameplay contexts, for example with respect to games. This supports differential treatment of object states where precision is more or less important, improving bandwidth utilization and simulation fidelity without introducing excess latency or computational overhead.

Another technical advantage of some implementations is the decoupling of game logic state (or a logic state from other types of experiences) from visual presentation state. By maintaining a separate reconciled visual presentation state that incorporates corrections based on reconciliation logic, the system enables smoother rendering of object motion over time without distorting the underlying simulation state. The separation enables temporal smoothing, interpolation, or latency concealment at the rendering layer while preserving the accuracy of the simulated game world (or other environment) and avoiding logical inconsistencies in player/user input or collision detection.

Another technical advantage of some implementations includes enabling rollback checks to use a magnitude-based threshold rather than binary state matching. This enables the architecture to quantify differences between authoritative and predicted states, and to skip rollback when the deviation falls within an acceptable tolerance. Such functionality is useful for objects with minimal visual impact or high-frequency updates, where frequent rollbacks would degrade performance or visual quality without materially improving accuracy.

Another technical advantage of some implementations includes support for temporal history access during reconciliation. Reconciliation techniques may incorporate past positions of an object over several frames to generate a smoothed or interpolated update, reducing jitter and visual discontinuities introduced by late authoritative updates. The capability is particularly beneficial in high-latency environments, where discrepancies between predicted and authoritative states occur regularly, and temporal smoothing can mask the effects of delay without undermining gameplay responsiveness.

Another technical advantage of some implementations includes supporting multiple prediction strategies. Prediction of object states for subsequent frames may be based on either prior predicted states or prior authoritative states, depending on availability. This enables the client to continue forward simulation when authoritative updates are delayed and provides flexibility to recover gracefully when updated information becomes available. By supporting both sources, the prediction logic can adapt to the network conditions and timing characteristics of the authority node.

Another technical advantage of some implementations includes the ability to define reconciliation and rollback behavior through declarative policy configurations supports modularity and extensibility. Developers can select from predefined compensation techniques such as interpolation or time warp and apply them selectively to specific objects or object classes. The modular policy control reduces development complexity, enables tuning for different gameplay etc. genres or platform capabilities, and enables runtime experimentation with minimal code changes.

### System Architecture

The present disclosure is directed towards, inter alia, techniques to generate contextually relevant code for 3D virtual assets (e.g., virtual objects in a virtual experience/environment) by utilizing representations of their geometric and semantic properties as input to a generative artificial intelligence (AI) model.

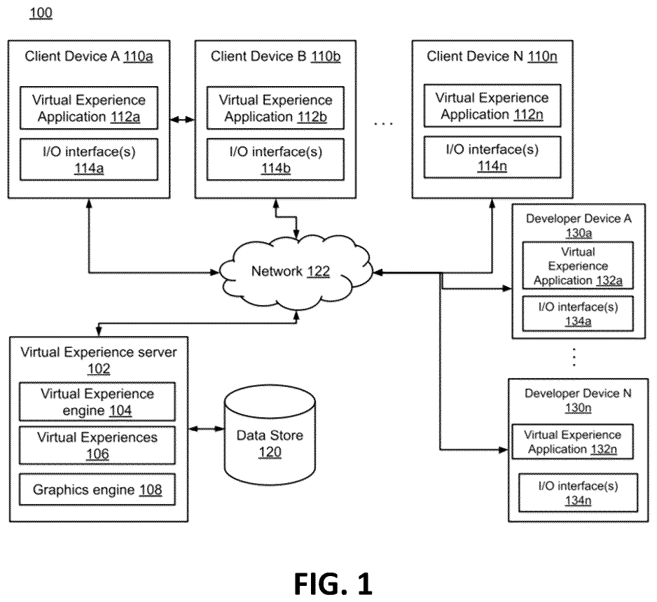

FIG. 1 is a diagram of an example system architecture that can be used to manage object states using a netcode architecture, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

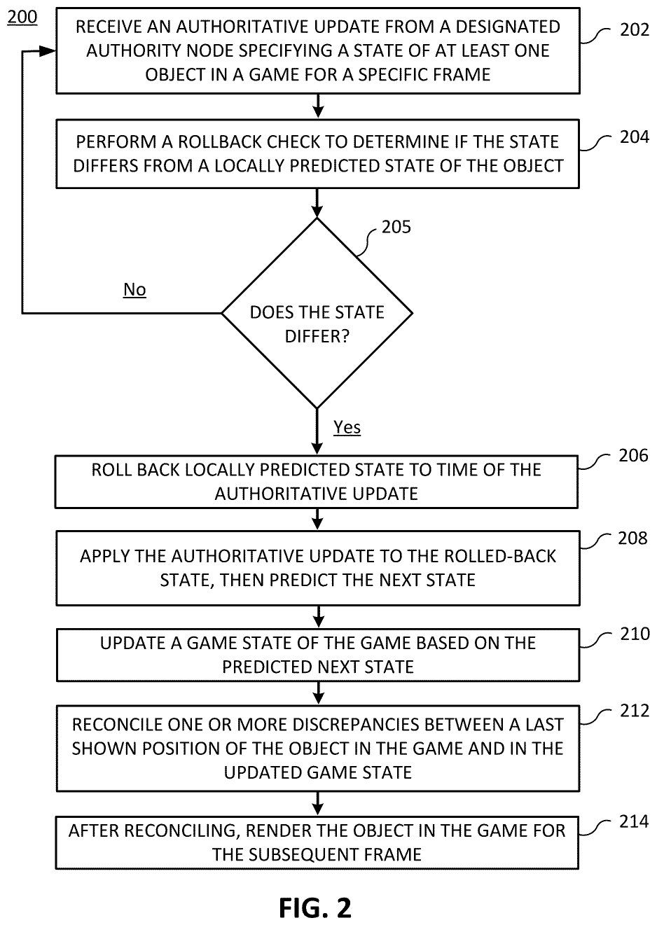

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user. ” In the context of a game, a “user” may be a player of a game. In some implementations, a “user” may be a developer or other individual with administrative or other control-type privileges who may not necessarily be the end user of a virtual experience environment.

In some implementations, online virtual experience server 102 may be or include a virtual gaming server. For example, the gaming server may provide single-player or multiplayer games to a community of users that may access a “system” herein that includes online virtual experience gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time or near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another. In some implementations, a virtual experience 106 hosts virtual objects whose states are being managed in the techniques described herein.

In some implementations, virtual experiences may have one or more environments (also referred to as “virtual experience environments”, “virtual environments”, or “virtual spaces”, etc. herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (e.g., an avatar) of the virtual experience may cross the virtual border to enter the adjacent virtual environment.

It may be noted that 3D environments or 3D worlds may use graphics that use a three-dimensional representation of geometric data representative of virtual experience content (or at least present virtual experience content to appear as 3D content whether or not 3D representation of geometric data is used). 2D environments or 2D worlds may use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects”or “virtual experience item(s)”herein) of virtual experiences 106.

For example, in generating user-generated virtual items, users may create characters (e.g., avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 may implement the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine or virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (e.g., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to enable an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users with access to simplified 3D virtual object models that are represented by a mesh of a low polygon count (e.g., between about 20 and about 30 polygons).

In some implementations, the user may control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to enable the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, the virtual experience server 102 includes a virtual experience engine 104 that executes logic to manage game state synchronization across distributed clients. The engine 104 may perform the techniques described herein, including generating and transmitting authoritative updates for object states at specific simulation frames, evaluating discrepancies between predicted and authoritative states, and applying reconciliation or rollback logic based on developer-defined policies. The virtual experience engine 104 of some implementations operates as the designated authority node, maintaining canonical object states and transmitting them to client devices 110 to maintain temporal alignment and simulation consistency across a multiplayer game session.

Client devices 110 execute a virtual experience application 112 that receives and processes authoritative updates generated by the server 102. In some implementations, the virtual experience application 112 maintains a locally predicted state of objects based on prior updates or simulation logic and performs rollback checks to compare against incoming authoritative updates. The virtual experience application 112 may apply correction techniques, such as, e.g., interpolation, extrapolation, or smoothing, to reconcile visual discrepancies between previously rendered object positions and the updated game state. The reconciled object state is rendered for the relevant frame to maintain a visually coherent experience, such as a gameplay experience. In certain configurations, the virtual experience application 112 may manage custom rollback or reconciliation behavior through developer-defined rules exposed via an API.

### Managing Object States Using a Netcode Architecture

FIG. 2 is a flow diagram illustrating an example method 200 to manage object states using a netcode architecture, in accordance with some implementations.

In various implementations, the blocks shown in FIG. 2A and described below may be performed by any of the computing devices illustrated in FIG. 1, for example, by one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, an authoritative update is received at a client device from a designated authority node. The authoritative update includes data that defines a current state of at least one object in a game environment for a specific frame in the simulation timeline. The state may include a set of property values or attributes associated with the object, such as spatial position, rotation, velocity, animation state, or logical status (e.g., health, inventory, or interaction flags). The object may include any entity in the game environment, including, for example, player avatars, non-player characters (NPCs), interactive elements such as levers or doors, or environmental features such as projectiles or physics-enabled structures.

A designated authority node includes a computing node within a networked simulation framework that is responsible for computing and broadcasting the definitive or ground-truth state of one or more objects. The node may be a server (e.g., the virtual experience server 102), a host client (e.g., the client device 110), or a dedicated authority depending on the architecture that provides the virtual experience environment. The designation of authority may be static (assigned at session start) or dynamic (based on object ownership transfer). The authoritative node computes object states based on global simulation logic, user inputs, and game rules, and communicates the results to other nodes, including client devices acting as replicas.

The authoritative update is received for a specific frame, which includes a discrete time step in the simulation. Frames may be identified by sequential indices or by timestamps, and are used to organize the progression of the simulation and rendering logic. For example, an authoritative update for frame 143 may specify that object A has position (12.3, 5.7, 0.0) and velocity (1.0, 0.0, 0.0), indicating that the object has moved along the x-axis. Frame-based identification enables the client device to align the received authoritative update with its own local simulation timeline, which may include speculative or predicted states for comparison and possible rollback.

The authoritative update may include state information for one or more objects. In some implementations, each object may be identified by a unique object identifier or handle. In some implementations, the update may be formatted as a structured message, such as, e.g., a binary or JavaScript Object Notation (JSON) payload, including key-value pairs or arrays representing per-object states. In some implementations, the update may be compressed or delta-encoded, transmitting only changes in state since a prior acknowledged frame. The state data may include, for example, scalar values, vector values, enumerated flags, or structured fields depending on the representation of the object in the game simulation.

In some implementations, the client device may store the received authoritative update in a local temporal data store, indexed by object identifier and frame index. This enables subsequent retrieval of authoritative state data for comparison against previously predicted states generated locally at the client. The authoritative update in some implementations is not directly rendered but is instead used for simulation validation, rollback, or other synchronization logic depending on the divergence between local and authoritative values.

In some implementations, reception of the authoritative update may occur through a dedicated communication channel, such as a reliable user datagram protocol (UDP) stream or websocket connection, maintained between the client device and the designated authority node. The update may be part of a continual stream of updates or a batched transmission. Timing characteristics of reception (e.g., latency, jitter) may vary based on network conditions, and client logic may include buffering or alignment mechanisms to account for delayed or out-of-order updates when integrating the authoritative data into local simulation state. Block 202 is followed by block 204.

At block 204, a rollback check is performed to determine if the state specified in the authoritative update differs from a locally predicted state of the at least one object at the client device. The rollback check includes a comparison that evaluates one or more attributes of an object as received from the authoritative node against those predicted and stored locally at the client for the same simulation frame.

A rollback check, as used herein, includes logic executed at the client device to determine a divergence/difference between authoritative and predicted object states. The rollback check may be triggered upon receipt of an authoritative update or may be performed periodically or otherwise repeatedly if multiple updates are buffered. The comparison may include absolute or relative differences between numerical attributes such as, e.g., position, velocity, or rotation; mismatches in discrete state flags; or structural differences in hierarchical object data such as skeletal bone positions or animation blend weights.

The locally predicted state of the object at the client device includes an estimate generated at the client based on prior authoritative states and locally available input or simulation logic. Prediction techniques may include, e.g., dead reckoning, local physics simulation, or interpolation/extrapolation techniques that estimate future object state assuming continuity or known control inputs. The predictions may be performed to hide network latency and maintain simulation continuity between updates. In some implementations, the predicted state is stored in a local memory buffer indexed by frame number and object identifier, enabling frame-specific comparisons.

In some implementations, performing the rollback check includes determining if the difference between the authoritative update and the locally predicted state meets a threshold, such as a pre-defined threshold or other type of threshold. For example, if the predicted position of an object at frame 150 is (5.0, 2.0, 0.0), but the authoritative update specifies (4.4, 2.0, 0.0), then the delta in the x-coordinate is 0.6. If a threshold for position drift is 0.5 units, the difference meets the threshold and the rollback check would result in a determination that a correction is needed. In some implementations, the criteria for determining a difference may be developer-configurable, such as per-property thresholds or object-type-specific rules.

In some implementations, the rollback check includes custom logic specified through a scripting interface, enabling game-specific criteria to be applied. For example, some object types (e.g., visual-only props) may be exempt from rollback, while others (e.g., player avatars or dynamic projectiles) may involve strict positional consistency. In some implementations, the check may be implemented as a Boolean decision or may return a set of fields requiring correction.

In some implementations, an API is provided to enable a developer of the game to specify custom logic for performing the rollback check. The rollback check includes a comparison between a locally predicted state and an authoritative update, and the custom logic enables the developer to define custom criteria that determine whether a rollback is to be performed based on specified conditions. In some implementations, the custom criteria may be defined using a scripting interface or configuration schema and may include criteria involving, e.g., object type, gameplay context, or numerical thresholds. In some implementations, the custom logic may operate as an override or supplement to a default rollback policy. For example, a developer may implement logic that prevents rollback for cosmetic objects whose visual discrepancies are unlikely to impact gameplay, while enabling rollback for interactive or physics-based objects. In some implementations, the API may support declarative or procedural logic definitions, enabling developers to write criteria that query the magnitude of a difference, determine the timing of updates, or consider recent input events. This flexibility enables the rollback behavior to be tuned to the requirements of a specific game or object class.

In some implementations, the custom criteria specified via the API may include an object type of the object to which the rollback check is being applied. The object type may indicate whether the object is interactive, cosmetic, physics-driven, or otherwise categorized within the game logic. A developer may use the classification to define rules that enable or suppress rollback behavior depending on a functional role of the object. For example, rollback may be enforced for player-controlled avatars or game-critical items, while being bypassed for static or decorative elements. The categorization can be referenced dynamically during the rollback check to enable context-sensitive state management.

In some implementations, the custom criteria specified via the API may include a magnitude of difference between the locally predicted state and the authoritative update. The magnitude of difference may be computed using one or more distance metrics, such as, e.g., Euclidean distance between object positions, angular deviation between orientations, or frame-to-frame delta in velocity or animation parameters. A developer may define a threshold magnitude beyond which rollback is triggered, thereby filtering out minor discrepancies that do not materially affect gameplay. This enables granular control over rollback behavior, enabling developers to prioritize performance and responsiveness while preserving state consistency in more impactful cases. Block 204 is followed by decision point 205.

At decision point 205, it is determined whether the state in the authoritative update differs from the locally predicted state of the object at the client device. If it is determined that the state specified in the authoritative update differs from the locally predicted state of the object, then decision point 205 is followed by block 206. If it is determined that the state specified in the authoritative update does not differ from the locally predicted state of the object, then decision point 205 is followed by block 202, and blocks 202-205 repeat until it is determined that the state specified in the authoritative update differs from the locally predicted state of the object.

At block 206, upon a determination that the state specified in the authoritative update differs from the locally predicted state of the object, the locally predicted state is rolled back to a prior point in time corresponding to the update. The authoritative update from the server is then applied to the rolled-back state to correct it. The rollback includes reversing any speculative simulation that was applied to the object based on the earlier, now-invalid predicted state, and resimulating forward from the corrected state, including the applied update, to bring the simulation up to the current frame.

Rolling back a locally predicted state includes accessing a buffer of previously stored object states, identifying the last frame at which the authoritative state and the predicted state were known to match, and overwriting all affected simulation state from that frame onward. The replacement state may include attributes such as, e.g., position, orientation, velocity, acceleration, animation pose, or any other properties representing the full state of the object. For example, if a projectile was speculatively simulated to move forward from a given frame based on a predicted input, and an authoritative update indicates the position at that frame is materially different, then the client discards the simulated positions for all subsequent frames and recomputes them starting from the new authoritative state.

In some implementations, rollback may also extend to other objects that have been causally influenced by the mispredicted object. For instance, if a mispredicted trajectory of a soccer ball led to a simulated collision with a glass bottle, which was then simulated to fall and shatter, a correction to the ball's trajectory may require also rolling back the state of the bottle and recomputing its behavior. Different implementations may choose how broadly to propagate rollback: some may roll back the entire simulation state, while others may selectively rollback only certain objects based on dependency graphs or rollback check functions applied per object. Tradeoffs may be made between accuracy and computational cost.

In some implementations, the rollback may include invalidating local simulation results, such as collision outcomes or gameplay events triggered during speculative frames. In some implementations, affected state transitions are marked as invalid and removed from the simulation history, while in others the rollback includes invoking custom-defined undo operations or reapplying inputs to re-simulate behavior deterministically. Where deterministic simulation is used, the same inputs originally applied to the predicted state are reapplied to the authoritative state to restore simulation consistency.

In some implementations, the rollback may include re-running game logic scripts or physics computations for each affected frame to generate corrected object states. In some cases, a rollback window size is enforced to limit how far back the simulation can be rewound, with earlier frames dropped or approximated if the update arrives too late. In some implementations, the rollback is confined to objects that exhibit divergence, enabling unaffected parts of the game state to proceed without interruption.

In some implementations, rollback is implemented per object, but in some cases may include dependencies across objects or systems. For example, rollback of a position of a character may require rollback of camera orientation, input buffers, or environmental effects. The client device maintains temporal state history and simulation determinism to support the operation without requiring a full state resend from the authoritative node. Block 206 is followed by block 208.

At block 208, a subsequent object state is predicted based on an updated object state that results from applying an authoritative update to a locally predicted state rolled back to a time corresponding to the authoritative update. An object state includes one or more parameters representing the simulated condition of an object in the game at a given point in time. These parameters may include position vectors, velocity vectors, orientation, angular velocity, animation state identifiers, bounding volumes, health values, or other game-specific attributes. In some implementations, prediction is not limited to individual objects in isolation. When resimulation is triggered for a particular object, the resimulation may also encompass other objects or entities that are causally influenced by that object. For example, if a resimulated ball collides with a window, both the ball and the window may be updated to reflect the interaction during forward prediction. In some cases, resimulation may extend to groups of related objects or to the entire local simulation region maintained at the client device.

In some configurations, the client device maintains only a subset of the full world state, depending on what content has been streamed or designated for prediction. For example, a client may locally store only the portion of a virtual world corresponding to a stadium environment, without distant or unstreamed elements such as terrain or foliage. Within that local region, a developer may designate specific objects or object categories, such as a ball and nearby non-player characters, for prediction and resimulation. Static or remotely authoritative objects, such as scoreboards or spectators, may remain excluded from local prediction. This selective prediction strategy supports localized forward simulation while preserving synchronization with the broader authoritative world state maintained at the server.

As used herein, prediction refers to a local estimation performed by the client device in the absence of a timely authoritative update. In various implementations, prediction may be based on known motion rules, gameplay logic, heuristics, or previously observed behaviors. The simulation state is advanced from the most recent available data. In some cases, prediction may be carried out using numerical integration techniques, such as Euler or Verlet integration, or by replaying previously captured user input events. For example, if the updated object state includes a known velocity vector at frame N, the position at frame N+1 may be predicted by incrementing the current position according to the velocity and time delta.

In some implementations, prediction is performed on a per-object basis and conditioned on contextual information such as environmental constraints, input state, or ongoing physics interactions. For instance, a client device may predict that a character continues to walk forward based on prior movement input, or that a projectile maintains its trajectory in accordance with its prior velocity and gravity. The logic for prediction may also include conditional transitions, such as transitioning to a landing animation upon detecting the end of a fall, or initiating a turn based on anticipated direction changes.

In some implementations, each predicted object state is stored with a timestamp corresponding to the target future frame, enabling lookup for rendering or later reconciliation. Predicted states are marked as speculative and subject to rollback or correction if an authoritative update is subsequently received. The predicted object state is committed to the local simulation buffer and may propagate through further prediction cycles if authoritative data is still unavailable, allowing the client to continue rendering in the interim.

In various implementations, prediction of the subsequent object state involves simulating object behavior based on the updated object state that results from applying the authoritative update. The simulation may use physics models, kinematic equations, or rule-based systems that describe object evolution under given inputs or environmental factors. For example, a next position of a character may be estimated based on its observed velocity and direction, or a projectile's arc may be extrapolated using Newtonian motion. The simulation proceeds from the updated object state, whether it originated from authoritative or previously predicted data, and advances to estimate the state of the object for the subsequent frame. This enables the client device to remain responsive by predicting and rendering object behavior in real time even before updated authoritative data is available. Block 208 is followed by block 210.

At block 210, a game state of the game is updated based on the predicted object state. As used herein, the “game state” refers to the collective simulation state tracked by the client at a given frame for one or more objects or systems. For each object, the client may maintain (1) the last known authoritative state received from the server, (2) the current predicted state, which is updated in this step based on the latest prediction logic, (3) a history of intermediate states, which may include full state records or compact digests (e.g., hashes) to support rollback or divergence detection, and (4) associated metadata such as whether the object is subject to prediction, and callback references or flags that define how rollback, reconciliation, or resimulation should be performed.

In some implementations, the overall game state is organized as a structured memory space, such as a dictionary or database, where object identifiers map to state descriptors and associated metadata. The updated predicted state is committed to the local game state for use in subsequent processing, including rendering, simulation, or comparison against future authoritative updates. Depending on implementation, the game state may also include runtime values associated with physics, animation, inventory, player statistics, or other gameplay-relevant parameters.

Updating the game state based on the predicted object state includes inserting or overwriting one or more values in the local game state representation at the client device with the output of the prediction. In some implementations, this includes directly modifying the local data structure that stores the state for the object, such as a per-object buffer indexed by object identifier and frame timestamp. For example, if the predicted position and velocity for a character were computed in block 208 for frame N+1, then the corresponding entries in the game state data structure for frame N+1 would be written with those predicted values.

In some implementations, the update may include marking the source of the entry as speculative to distinguish it from authoritative data. In some implementations, separate storage locations may be maintained for speculative and authoritative values. The update may include propagating dependent effects, such as, e.g., updating collision structures, triggering proximity-based events, or queuing changes for rendering or audio systems.

In some implementations where multiple objects are predicted concurrently, the game state update may include batching multiple predicted states into a unified update cycle for a single frame. Additionally, the update may be deferred or staged through command queues to preserve determinism across platforms or sessions. The result of the update is a modified local representation of the game state that includes the predicted evolution of the simulation in the absence of new authoritative data. Block 210 is followed by block 212.

At block 212, one or more discrepancies are reconciled between a last shown position of the at least one object in the game and a position of the object specified in the updated game state. A discrepancy may include any measurable divergence between the visual presentation of an object at the client device and the underlying game state that has been updated based on authoritative or predicted data. The last shown position includes the position of the object as previously rendered or displayed in the most recent frame presented to the user. In some implementations, the position may originate from a prior prediction, interpolation, or speculative update, and is stored separately in a visual buffer or cache.

In some implementations, the frequency of reconciliation or resimulation may be limited to avoid excessive computational load on the client device. For example, reconciliation updates may be performed at a bounded rate (e.g., up to ten times per second) rather than continuously on each frame. This prevents scenarios in which repeated corrections trigger further divergence and resimulation, which could otherwise cause performance degradation or cascading latency effects. Such rate-limiting mechanisms ensure temporal stability in client-side prediction and reconciliation while maintaining visual consistency with the updated game state.

In some implementations, reconciliation includes modifying a presentation-specific representation of the object state so that the transition from the last shown position to the position in the updated game state is visually continual. In some implementations, this includes computing an interpolated or smoothed transformation that bridges the gap between the two states over one or more frames. The reconciliation may apply to, e.g., position, rotation, scale, or other visual properties, and may include animation blending or pose correction. For example, if the last shown position of an object places it at coordinate (x1, y1, z1) and the updated game state places it at (x2, y2, z2), then a transition curve may be applied to animate the change across several frames.

In systems that maintain separate logical and visual views of the game state, the reconciliation operation may include writing the adjusted state to a visual view buffer. The buffer includes the values that will be used for rendering in the upcoming frame but does not affect the core simulation logic. Such separation enables smoothing visual artifacts caused by mispredictions, rollbacks, or network delay without modifying the logical state used by the physics engine or gameplay rules. The visual view may be timestamped or versioned to maintain consistency with the corresponding simulation frame.

Reconciliation techniques may be implemented using a range of heuristics or policies, such as linear interpolation, cubic spline interpolation, exponential decay, or damped spring models. The reconciliation may be applied conditionally, such as when the magnitude of the discrepancy meets a threshold or when the object is determined to be player-visible.

In some implementations, an API is provided to enable a game developer to define a policy that specifies a criterion that indicates when to perform the reconciling of the one or more discrepancies and that specifies techniques to perform the reconciling. The API includes one or more interfaces that enable the developer to specify a criterion for triggering reconciliation, such as a divergence between the last shown position of an object and its updated position in the game state. In various implementations, the criterion can be based on a quantitative difference in object attributes (e.g., position, rotation, velocity), a time-based threshold (e.g., number of frames since last alignment), or other game-specific parameters. In some implementations, the API enables the developer to define a reconciliation that is to be applied when the criterion is met, such as, for example, replacing the last shown position with the updated value, performing an interpolation over multiple frames, or initiating an object-specific correction routine.

In some implementations, the reconciliation policy specified using the API may include declarative or procedural components. For example, a developer may implement a reconciliation rule as a function that takes as input the previous rendered frame and the updated game state, compares selected fields, and outputs an updated visual state. This enables customization of smoothing behavior to suit different object types or gameplay contexts. The API may support callback registration for a reconciliation event, which is invoked during the rendering pipeline after the simulation has advanced the game state, but before the frame is presented to the player.

In some implementations, the policy specifies compensation techniques selected from a group including, e.g., interpolation, extrapolation, incoming delay, latency concealment, attribute scaling, time warp, and combinations thereof. In some implementations, the techniques may be specified in the policy configuration and invoked during the rendering stage to adjust the presentation of object states based on differences between the previously shown position and the updated game state. Interpolation can include computing intermediate object states between two known states (e.g., the last shown state and the updated game state) to produce a smooth transition over a series of frames. Extrapolation can include projecting future states based on current velocity or trajectory to reduce visible latency when updates are delayed. Incoming delay can include delaying the application of updates to synchronize object state changes across distributed clients. Latency concealment can include methods that obfuscate or reduce the perceptual effects of delayed updates. Attribute scaling can include adjusting object-specific properties, such as reducing the magnitude of velocity or displacement during correction. Time warp can include adjusting the perceived simulation time of the object to align it with visual continuity. In some implementations, the policy may include rules to select among the techniques based on, e.g., object type, discrepancy magnitude, player proximity, or other gameplay-relevant criteria.

In some implementations, the API enables developers to configure both how an object state is predicted in the absence of authoritative updates and how mispredictions are reconciled once an update is received. For example, prediction strategies may include best-effort simulation using prior speculative inputs, while reconciliation strategies may include interpolation or smoothing techniques that minimize visual discontinuity. These configuration options may be exposed through policy definitions or runtime parameters, and may be set globally or on a per-object basis depending on gameplay constraints or object characteristics.

A best-effort prediction reflects the most recent locally computed object state based on speculative inputs and simulation logic without authoritative confirmation. An interpolated visual estimate may be derived by blending between previously known authoritative states, prior rendered positions, or frame histories, using parameters such as motion vectors and timestamps. Developers may select whether to emphasize responsiveness through prediction or visual smoothness through interpolation during reconciliation, with separate configuration controls for each.

In some implementations, reconciling includes accessing a history of last shown positions of the object across multiple frames and smoothing the updated game state accordingly. The history may include a sequence of positional data points rendered for the object over recent frames, stored in a local visual buffer at the client device. By comparing the updated game state—derived from authoritative updates or new predictions—with the historical trajectory of the object as previously rendered, smoothing functions may be applied to interpolate or gradually transition between positions.

The smoothing may include, for example, linear interpolation, spline-based curves, or velocity-constrained blending to reduce abrupt visual discontinuities. In certain implementations, the reconciliation process is not fixed in the engine but is instead performed via a callback function registered by the developer. This callback may control how smoothing is applied for different object types or gameplay scenarios, enabling application-specific logic for handling discrepancies. Block 212 is followed by block 214.

At block 214, after the reconciling of the discrepancies, the object in the game is rendered for the subsequent frame. Rendering includes generating graphical output for display on the client device based on a set of visual parameters associated with the object. In various implementations, the parameters may include, e.g., position, orientation, scale, animation pose, shading properties, and other values required by the graphics engine to draw the object on screen. The subsequent frame includes the next simulation or display frame that follows the reconciliation in the update loop of the game.

In some implementations, the rendering may operate on a visual representation of the object stored in a visual state buffer. The buffer includes values computed or modified during reconciliation and may differ from the game logic state maintained in the simulation engine. The graphics engine accesses the visual representation and submits corresponding draw calls or rendering instructions to a rendering pipeline, which may include stages such as, e.g., vertex processing, rasterization, fragment shading, and compositing. If the visual state is interpolated or blended during reconciliation, the rendered output reflects a smoothed transition that masks underlying discrepancies.

In some implementations that include layered or hierarchical rendering, the rendered output of the object may be composited with other scene elements such as, e.g., environment geometry, effects, and user interface components. The rendered object may be affected by view-dependent factors including, e.g., camera position, perspective projection, and occlusion from other geometry. Depending on the rendering architecture, the frame may be assembled using a fixed or variable timestep, and visual updates may be synchronized to display refresh cycles using techniques such as vertical sync (VSync) or frame pacing.

In some implementations, the rendered output for the object in the subsequent frame is displayed to the user as part of a complete scene. The scene reflects the current state of the game world as perceived by the client device, incorporating any authoritative updates received from the designated authority node, predictions made locally, and reconciliation performed to maintain visual continuity. Rendering concludes the processing for the current frame and prepares the system for the next iteration of the game loop, which begins with receiving any new authoritative updates or input events.

In some implementations, the rendering of the object in the game is based on a visual presentation state that incorporates corrections from the reconciling. The visual presentation state includes a version of the state of the object that is specifically prepared for display purposes, distinct from the underlying game logic state used for simulation or authoritative consistency. The visual presentation state may be maintained in a separate view or buffer at the client device and updated as part of the reconciliation. Corrections applied during reconciliation, such as interpolated transitions or smoothed positional adjustments, are written to the visual presentation state to reflect the most recent reconciled view of the object. The rendering engine references the corrected view when generating the frame to be displayed to the user, enabling visually continual animation that avoids abrupt transitions caused by differences between locally predicted and authoritative values.

In some implementations, one or more of blocks 202-214 may be performed by one or more server devices, and one or more of blocks 202-214 may be performed by one or more client devices. In some implementations, all of method 200 may be performed by a server device, or by a client device. In some implementations, one or more of blocks 202-214 may be performed in parallel. For example, in some implementations, blocks 206 and 208 may be performed in parallel. According to various implementations, blocks may be added, deleted, modified, combined, supplemented with other blocks, performed in a different order than as shown and described, performed in parallel, and so forth.

In various implementations, the techniques described herein may include different combinations of the features described above. For example, an authoritative update may be received from a designated authority node, the authoritative update specifying a state of at least one object in a game for a specific frame. A rollback check is performed to determine whether the state specified in the authoritative update differs from a locally predicted state of the at least one object at the client device. If a difference is detected, the locally predicted state is rolled back to a time corresponding to the authoritative update, and the authoritative update is applied to obtain an updated object state. A subsequent object state is then predicted based on the updated object state, and a game state of the game is updated based on the predicted object state. One or more discrepancies are reconciled between a last shown position of the at least one object in the game and a position of the object in the updated game state. After reconciling, the at least one object is rendered for the subsequent frame. In some of these implementations, performing the rollback check includes determining whether the difference between the authoritative update and the locally predicted state meets a threshold. Additionally or alternatively, an application programming interface (API) may be provided to define a policy that specifies when to perform reconciling and what techniques to use during reconciliation.

In some implementations, an API enables a developer of the game to specify custom logic for performing the rollback check, including rules to determine whether rollback should occur based on custom criteria. Such criteria may include an object type of the at least one object, a magnitude of difference between the locally predicted state and the authoritative update, or dependency relationships indicating whether nearby or causally linked objects are to be rolled back in tandem.

In some implementations, the API used to define reconciliation policy specifies compensation techniques selected from a group comprising interpolation, extrapolation, incoming delay, latency concealment, attribute scaling, time warp, or combinations thereof.

The API may also enable selection between using a predicted object state and an interpolated visual estimate when reconciling discrepancies between the last shown position and the updated game state. In some implementations, separate configurations are provided for how prediction is performed and how discrepancies are reconciled, allowing independent tuning of responsiveness and visual smoothness.

In some implementations, predicting the subsequent object state includes simulating object behavior based on the updated object state that results from applying the authoritative update. The simulation may further include other objects causally influenced by the updated object, thereby maintaining local consistency across dependent entities. These operations are performed in combination with receiving the authoritative update, performing the rollback check, and updating the game state maintained at the client device.

In some implementations, reconciling one or more discrepancies includes accessing a history of last shown positions of an object across multiple frames and smoothing the updated game state accordingly. Smoothing may be implemented using developer-supplied callback functions that apply interpolation or velocity-constrained blending. The reconciliation is performed after predicting the subsequent object state and before rendering the at least one object for the subsequent frame.

In some implementations, rendering the at least one object for the subsequent frame is based on a visual presentation state that incorporates corrections generated during reconciliation. The corrected presentation state provides a visually continuous transition between the last shown position and the updated game state.

The combinations described above may be implemented in different contexts. For example, in one implementation, an authoritative update is received, a rollback check is performed, and a difference threshold is applied; discrepancies are reconciled using an API-defined policy that includes interpolation and latency concealment; developer-specified rollback logic operates based on object type and causal dependencies; and the simulation predicts forward from the updated object state to the subsequent frame. Prior frame positions may be accessed to smooth discrepancies, and rendering uses a presentation state corrected through the reconciliation process. In another example, the API allows independent selection between prediction and reconciliation techniques to balance performance and visual fidelity.

Each of the foregoing combinations and sub-combinations may be used independently or in conjunction with one another. Sub-combinations such as threshold-based rollback without reconciliation policies, or smoothing without exposing APIs to developers, may also be used. Implementations can be configured based on platform constraints, performance targets, object types, or developer preferences.

### Rollback and Reconciliation to Manage Object States

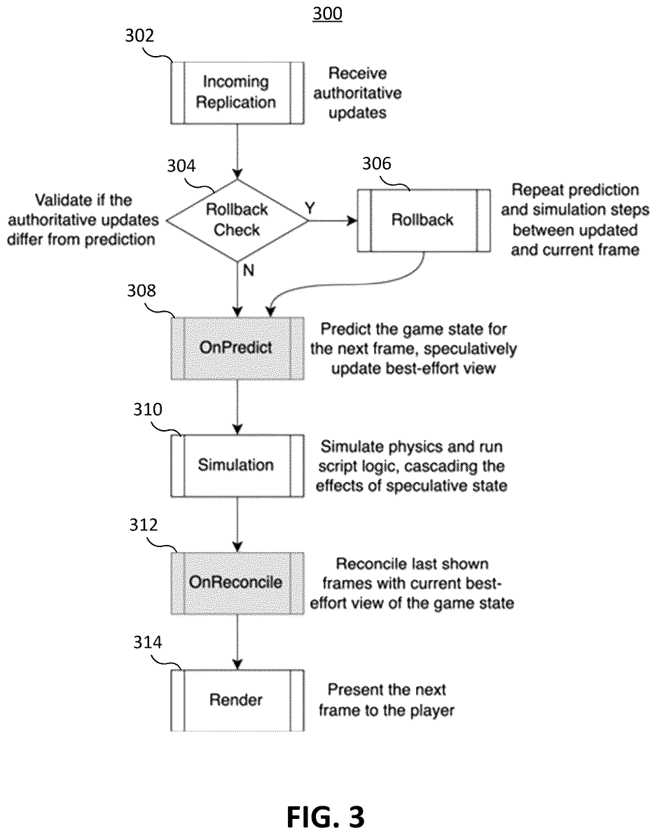

FIG. 3 illustrates an example of another method 300 to manage object states in a virtual experience, in accordance with some implementations. In some implementations, method 300 may be performed on a client device, e.g., a client device of a user that participates in a game or virtual experience provided by virtual experience server 102, with any number of other participants in the same game/virtual experience (e.g., a game instance) that use their own respective client devices. In some implementations, portions of method 300 may be performed on a server. In some implementations, each client device may perform its own method 300, based on the different latencies and discrepancies of the client device. Method 300 begins at block 302.

In FIG. 3, authoritative updates are received (block 302) at a client device from a designated authoritative node, such as a server node, within a multiplayer network, in techniques which may be referred to as incoming replication. In some implementations, the authoritative updates are received by a client node. Authoritative updates provide the ground-truth state information for objects within a virtual experience, enabling all clients within a multiplayer environment to have a consistent and synchronized representation of a game state (a collection of information and properties within a virtual experience at a specific point in time). A game state may include, for example, positions, attributes, and interactions of all objects, characters, and environmental elements that populate the virtual environment of the virtual experience. In some implementations, a recent state of at least one object in a virtual environment is provided. The authoritative updates may include properties such as, e.g., object position, object velocity, or an interaction state of objects that have changed due to actions in the multiplayer session. Block 302 is followed by block 304.

Once the authoritative update is received, a rollback check is performed (block 304) to validate or otherwise determine whether the locally predicted state at the client device deviates/differs from the authoritative update. A rollback may include reverting a local game state to a prior, authoritative version in order to correct discrepancies between predicted and actual object states. A rollback check may include comparing a locally predicted game state with an authoritative update to determine whether the discrepancy between them meets a threshold, such that a rollback is to be performed to correct the game state.

In some implementations, during the rollback check, the predicted state of the object is compared to the authoritative state based on local computations (at the client device), in order to determine if the discrepancy is sufficiently significant to warrant a corrective action. In some implementations, the determination is performed using a threshold that defines how much deviation is acceptable before a rollback is to be performed. If the predicted state falls within an acceptable range (e.g., does not meet the threshold), a rollback is not performed. If the discrepancy meets or exceeds the threshold, a rollback is initiated.

In some implementations, an API is provided that enables a developer to specify custom logic for performing the rollback check, where the custom logic includes a set of rules for determining when to roll back the local object state based on custom, e.g., experience-specific, criteria. Developers may thus tailor the rollback mechanism according to the needs of their virtual experience, considering factors such as, e.g., object type, interaction priority, or player perception. For example, a developer may define conditions such that highly visible objects, such as an avatar of a player or a key item, trigger immediate rollback corrections whenever discrepancies meet a threshold. For less key objects or background objects, the rollback logic may be modified or reduced in order to reduce computational overhead, only correcting discrepancies if they surpass a larger threshold or impact player experience. The API enables developers (game developers that build and define the game/virtual experience) to use additional contextual elements, such as the distance between the object and the viewpoint of the player, to decide whether a rollback is to be performed.

In some implementations, the rollback check criteria may include a magnitude of the difference between the predicted state and the authoritative update. Developers are enabled to set thresholds that specify when a rollback is to be performed based on the extent of the error. If the discrepancy between the predicted and authoritative states is small and unlikely to be noticeable to players (e.g., the discrepancy does not meet the threshold), a rollback may be skipped to avoid unnecessary interruptions, whereas significant differences (e.g., the discrepancy does meet the threshold) are corrected to maintain accurate and consistent virtual experiences. Block 304 is followed by block 306.

If a rollback is to be performed, a rollback (block 306) of the local object state is performed to match the authoritative state. During rollback, the version of the object associated with the client is corrected according to the authoritative update. In various implementations, the rollback includes adjusting properties such as, e.g., position, velocity, or any other relevant attribute of the object. In some implementations, rollback is performed and the rest of the method 300 continues, with the game state and object state after completion of the rollback being used as input to the prediction in block 308, described below. As part of the prediction process, the system may repeat the prediction and simulation steps for one or more intermediate frames between the updated frame (from the authoritative update) and the current frame being rendered. This repetition allows the system to reconstruct a forward-predicted object state consistent with the game timeline. If the rollback is not performed, the local object state continues to be used as it is. Block 306 is followed by block 308.

If it is determined during the rollback check that the discrepancy is not significant enough to warrant a rollback (does not meet the threshold), game state is predicted (block 308) for an upcoming frame. In some implementations, the game state is predicted based on the authoritative update and prior object characteristics, such as, e.g., object velocity, position, and direction. The prediction is used to update a game state. In some implementations, a best-effort view of the game state is updated. The best-effort view of the game state represents a locally maintained, speculative representation of the virtual environment, updated based on predictions to provide a continual movement of objects and characters within the virtual environment until authoritative updates are received. Block 308 is followed by block 310.

In some implementations, object interactions are simulated (block 310) based on the predicted state. A local physics simulation is performed, and applicable script logic is executed, which in various implementations may include cascading effects resulting from the speculative state. If the predicted position of an object leads to interactions with other entities within the virtual experiences, the physics engine processes the interactions according to a set of rules. Block 310 is followed by block 312.

One or more discrepancies are reconciled (block 312). In some implementations, differences are reconciled between the last shown frame and the game state (e.g., a current best-effort view of the game state). Despite speculative predictions, discrepancies may still arise between the predicted state and the authoritative state eventually received. The reconciliation adjusts the position or other properties of the object incrementally to match the authoritative state.

In some implementations, an API is provided that enables a developer to specify a policy for determining when and how to perform the reconciliation of one or more discrepancies between the predicted state and the authoritative state. The policy enables developers to take into account specific dynamics and adjust reconciliation behavior accordingly, enabling visual consistency of object positions while reducing any disruptive changes in the experience of the player. For example, a developer may set different reconciliation techniques based on the movement type of an object, such as using interpolation to smoothly correct discrepancies for slow-moving or stationary objects, while utilizing extrapolation for fast-moving entities where predictions are likely to deviate from the authoritative state.

In various implementations, the policy for reconciliation is based on one or more of the following compensation techniques: interpolation, extrapolation, incoming delay, latency concealment, attribute scaling, and time warp. Interpolation includes estimating the state of the object by averaging between known points, which provides a smooth correction path when discrepancies are minor, reducing abrupt visual changes. Extrapolation is used when predicting where an object will be in the future, based on its current velocity and trajectory, which is particularly useful for fast-moving objects. Incoming delay enables the system to buffer updates briefly, reducing the frequency of corrections but introducing a slight delay, which can help conceal discrepancies in fast-changing scenarios. Latency concealment techniques, such as attribute scaling and time warping, enable subtle manipulation of object properties or the perceived passage of time, creating the illusion of seamless continuity in object movement despite underlying discrepancies. Block 312 is followed by block 314.

The reconciled game state is rendered (block 314), presenting the updated object state in the virtual environment, including presenting the next frame(s) of the virtual environment to the player(s)/user(s). The rendering enables the object to appear in the position that matches the reconciled state. In some implementations, visual adjustments like lighting or shading are performed based on the reconciled state.

### Computing Device

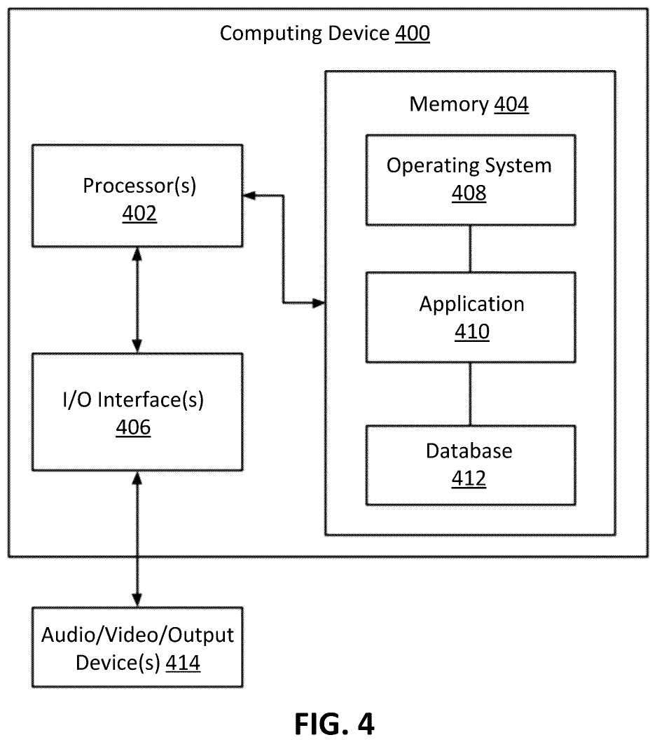

FIG. 4 is a block diagram of an example computing device 400 which may be used to implement one or more techniques described herein. In one example, device 400 may be used to implement a computer device (e.g., server 102 and/or client device 110 of FIG. 1), and perform method implementations described herein. Computing device 400 can be any suitable computer system, server, or other electronic or hardware device. For example, the computing device 400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 400 includes a processor 402, a memory 404, input/output (I/O) interface 406, and audio/video input/output devices 414.

Processor 402 can be one or more processors and/or processing circuits to execute program code and control basic operations of the device 400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

In some implementations, the one or more processors may directly perform one or more of the described operations, or may control performance of one or more of the operations by coordinating with other components of the system, such as dedicated rendering hardware, a physics engine, or a separate simulation module.

Memory 404 is provided in device 400 for access by the processor 402, and may be any suitable computer-readable or processor-readable storage medium, e.g., random access memory (RAM), read-only memory (ROM), electrical erasable read-only memory (EEPROM), flash memory, etc., suitable for storing instructions for execution by the processor, and located separate from processor 402 and/or integrated therewith. Memory 404 can store software operating on the device 400 by the processor 402, including an operating system 407, one or more applications 410, and a database 412 that may store data used by the components of device 400.

Database 412 may store one or more mechanisms, including authoritative state data, speculative state predictions, and configurations to manage object states in a distributed multiuser environment. In some implementations, database 412 may store information associated with game objects, such as unique identifiers for each object, metadata describing their movement and interaction properties, and data representing their states across frames. The stored data can include, e.g., historical state records, simulation configurations, and specific versions of the object states that are used during reconciliation and rollback. For example, in a multiplayer game environment, the database might store both the authoritative state and the corresponding speculative states, indicating how specific predictions influenced the gameplay experience. In some implementations, database 412 may store other data relevant to state management, such as rollback check histories, configurations for prediction mechanisms, and session information for managing frame-by-frame synchronization across different clients. Applications 410 can include instructions that enable processor 402 to execute the described techniques, such as managing state prediction, conducting rollback checks, and handling reconciliation between speculative and authoritative states.

For example, applications 410 can include a module that implements one or more techniques or services described herein, such as performing rollback checks based on custom logic, managing speculative state predictions, or integrating game-specific criteria into rollback decisions. Applications 410 can incorporate real-time or near-real-time updates that monitor the progress of object state management, enabling the displayed state to remain aligned with the authoritative updates and player interactions. The applications may employ various mechanisms to enable the reconciliation of discrepancies, including handling speculative versus authoritative states, determining rollback thresholds, and incorporating context-based rules during reconciliation. Database 412 (and/or other connected storage) can store various data used in the described techniques, including object identifiers, historical state records, rollback configurations, and parameters for determining the necessity of rollbacks or reconciliation based on specific object behaviors.

Elements of software in memory 404 can alternatively be stored on any other suitable storage location or computer-readable medium. In addition, memory 404 (and/or other connected storage device(s)) can store instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the device 400 with other systems and devices. For example, network communication devices, storage devices (e.g., memory and/or data store 120), and input/output devices can communicate via interface 406. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 414 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 4 shows one block for each of processor 402, memory 404, I/O interface 406, and software blocks of operating system 408 and virtual experience application 410. The blocks may represent one or more processors or processing circuitries, operating systems, memories, I/O interfaces, applications, and/or software engines. In other implementations, device 400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 400 can be a server device or client device. Example client devices or user devices can be computer devices including some similar components as the device 400 (e.g., processor(s) 402, memory 404, and I/O interface 406). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 414, for example, can be connected to (or included in) the device 400 to display images pre-and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
receiving, at a client device, an authoritative update from a designated authority node, the authoritative update specifying a state of at least one object in a game for a specific frame;
performing a rollback check to determine if the state specified in the authoritative update differs from a locally predicted state of the at least one object at the client device;
if the locally predicted state differs from the state specified in the authoritative update, rolling back the locally predicted state to a time corresponding to the authoritative update;
applying the authoritative update to the rolled-back state to obtain an updated object state and predicting a subsequent object state based on the updated object state;
updating a game state of the game based on the predicted object state;
reconciling one or more discrepancies between a last shown position of the at least one object in the game and a position of the object in the updated game state; and
after reconciling, rendering the at least one object in the game for the subsequent frame.

2. The computer-implemented method of claim 1, wherein performing the rollback check comprises determining if the difference between the authoritative update and the locally predicted state meets a threshold.

3. The computer-implemented method of claim 1, further comprising:
providing an application programming interface (API) that is usable by a developer of the game to define a policy that specifies a criterion that indicates when to perform reconciling the one or more discrepancies and that specifies techniques to perform reconciling the one or more discrepancies, wherein the reconciling is based on the updated object state obtained after applying the authoritative update.

4. The computer-implemented method of claim 3, wherein the policy specifies compensation techniques selected from a group comprising interpolation, extrapolation, incoming delay, latency concealment, attribute scaling, time warp, or combinations thereof.

5. The computer-implemented method of claim 3, wherein the API enables selection between using a predicted object state and an interpolated visual estimate when reconciling the one or more discrepancies.

6. The computer-implemented method of claim 1, further comprising:
providing an API that enables a developer of the game to specify custom logic to perform the rollback check, wherein the custom logic comprises rules to determine whether to roll back the locally predicted state based on custom criteria.

7. The computer-implemented method of claim 6, wherein the custom criteria comprise an object type of the at least one object.

8. The computer-implemented method of claim 6, wherein the custom criteria comprise a magnitude of difference between the locally predicted state and the authoritative update.

9. The computer-implemented method of claim 1, wherein the predicting the object state for the subsequent frame comprises simulating object behavior based on the updated object state after applying the authoritative update and one or more prior predicted or authoritative states.

10. The computer-implemented method of claim 1, wherein reconciling the one or more discrepancies is performed by accessing a history of last shown positions of the object across multiple frames and smoothing the updated game state accordingly, wherein the smoothing is performed by a callback function.

11. The computer-implemented method of claim 1, wherein rendering the at least one object in the game is based on a visual presentation state that incorporates corrections from reconciling the one or more discrepancies.

12. A computing device comprising:
one or more processors; and
memory coupled to the one or more processors with instructions stored thereon that, when executed by the one or more processors, cause the one or more processors to perform or control performance of operations comprising:
receiving, at a client device, an authoritative update from a designated authority node, the authoritative update specifying a state of at least one object in a game for a specific frame;
performing a rollback check to determine if the state specified in the authoritative update differs from a locally predicted state of the at least one object at the client device;
if the locally predicted state differs from the state specified in the authoritative update, rolling back the locally predicted state to a time corresponding to the authoritative update;
applying the authoritative update to the rolled-back state to obtain an updated object state and predicting a subsequent object state based on the updated object state;
updating a game state of the game based on the predicted object state;
reconciling one or more discrepancies between a last shown position of the at least one object in the game and a position of the object in the updated game state; and
after reconciling, rendering the at least one object in the game for the subsequent frame.

13. The computing device of claim 12, wherein performing the rollback check comprises determining if the difference between the authoritative update and the locally predicted state meets a threshold.

14. The computing device of claim 12, wherein the instructions further cause the one or more processors to perform or control performance of an operation comprising:
providing an application programming interface (API) that is usable by a developer of the game to define a policy that specifies a criterion that indicates when to perform reconciling the one or more discrepancies and that specifies techniques to perform reconciling the one or more discrepancies.

15. The computing device of claim 14, wherein the policy specifies compensation techniques selected from a group comprising interpolation, extrapolation, incoming delay, latency concealment, attribute scaling, time warp, or combinations thereof.

16. A non-transitory computer-readable medium with instructions stored thereon that, when executed by a processor, cause the processor to perform or control performance of operations comprising:
receiving, at a client device, an authoritative update from a designated authority node, the authoritative update specifying a state of at least one object in a game for a specific frame;
performing a rollback check to determine if the state specified in the authoritative update differs from a locally predicted state of the at least one object at the client device;
if the locally predicted state differs from the state specified in the authoritative update, rolling back the locally predicted state to a time corresponding to the authoritative update;
applying the authoritative update to the rolled-back state to obtain an updated object state and predicting a subsequent object state based on the updated object state;
updating a game state of the game based on the predicted object state;
reconciling one or more discrepancies between a last shown position of the at least one object in the game and a position of the object in the updated game state; and
after reconciling, rendering the at least one object in the game for the subsequent frame.

17. The non-transitory computer-readable medium of claim 16, wherein performing the rollback check comprises determining if the difference between the authoritative update and the locally predicted state meets a threshold.

18. The non-transitory computer-readable medium of claim 16, wherein the instructions further cause the processor to perform an operation comprising:
providing an application programming interface (API) that is usable by a developer of the game to define a policy that specifies a criterion that indicates when to perform reconciling the one or more discrepancies and that specifies techniques to perform reconciling the one or more discrepancies.

19. The non-transitory computer-readable medium of claim 18, wherein the policy specifies compensation techniques selected from a group comprising interpolation, extrapolation, incoming delay, latency concealment, attribute scaling, time warp, or combinations thereof.

20. The non-transitory computer-readable medium of claim 18, wherein the API enables selection between using a predicted object state and an interpolated visual estimate when reconciling the one or more discrepancies.
